(19) United States
(12) Patent Application Publication
(10) Pub. No.: US 2016/0365712 A1
(43) Pub. Date: Dec. 15, 2016

(54) Signal-Protecting Demarcated Cable Entry Housing

(71) Applicants: Ian T. BURNS, Sandy, OR (US); Nicholas J. SLINDE, Lake Oswego, OR (US)

(72) Inventors: Ian T. BURNS, Sandy, OR (US); Nicholas J. SLINDE, Lake Oswego, OR (US)

(73) Assignee: Termabox LLC, Portland, OR (US)

(21) Appl. No.: 14/736,538

(22) Filed: Jun. 11, 2015

(51) Int. Cl. H02G 3/10; H02G 3/16; H01R 13/74

(52) U.S. Cl. CPC H02G 3/10; H01R 13/74; H02G 3/16

(57) ABSTRACT

Embodiments of the invention are sturdy, weather-resistant enclosures to protect low-voltage and signal cables (and connections there between) when located on an exterior surface of a building such as a residence. The enclosure interior is separated into at least two internal volumes, and access to a first of these volumes is restricted by a locking mechanism. The locking mechanism may use standard electrical data-connection components rather than a keyed lock. Other characteristics and details of the enclosures are also described and claimed.

### CONTINUITY AND CLAIM OF PRIORITY

This is an original U.S. patent application.

### FIELD

The invention relates to boxes and housings for electrical equipment. More specifically, the invention relates to weather-resistant, wall-mounted housings for protecting low-voltage and signal-carrying cables from environmental conditions and unauthorized physical access.

### BACKGROUND

A variety of services and utilities are delivered to consumers' residences via pipes, wires and cables. These conduits are often owned, administered and maintained by the service provider up to the customer's exterior walls, while any interior wiring or plumbing is the customer's responsibility. Service providers have developed various mechanisms to protect their delivery conduits from damage, service theft and harmful interference that might be caused by conditions within the customer's premises.

One service that fits this model is the delivery of entertainment media (e.g., audio and video) through a system colloquially known as “cable TV.” Cable systems often provide additional services, such as telecommunications (e.g., telephone) and computer data communications (e.g., Internet access) over the same physical wires. Cable systems often have a branching structure, with higher-capacity trunk cables traveling to a central point in a neighborhood, then smaller-capacity feeder cables traveling to clusters of homes, and finally individual drop cables traveling to each separate service delivery point.

One challenge in providing high-quality (i.e., high speed, low interference) data service is that signal degradation can occur if the physical cables are damaged (often by bending more sharply than specifications permit), or if devices at or inside the customer's location are not solidly connected. Loose or unterminated connections can cause signal reflections and other artifacts that impact both the customer's own data transfer rates, as well as the communications of nearby service recipients. The penalty for mishandling comes in increased signal losses, reflection quirks and impedance mismatches, leading to higher VSWR (Voltage Standing Wave Ratio) and instability of other characteristics. Any of these can have a serious effect on overall system performance. Even if a cable system is 100% encrypted and theft of service is not a concern, it is disfavored to leave a non-subscribing home hooked up with active cable lines feeding into the house. The line should always be terminated before entering the house because the potential for noise/interference created from within the home of a non-revenue generating residence greatly exceeds the cost of lowering overall signal quality to paying subscribers which generates service calls and unsatisfied customers.

Cable providers' typical procedure for signal termination, reconnection, and placement of service filters/traps are completed at their existing demarcation point known as the tap. Taps are located either on aerial utility poles or underground at the cluster-of-homes level inside a “pedestal” from which drop cables routed to individual homes emanate. Aerial taps are usually easier to locate, but often are more difficult to access due to various obstacles blocking pole access via ladder or bucket truck. No matter aerial or underground plant, the tap may be located at a distance or on other neighbors' property and difficult to locate or safely access during a service call to one particular customer's location. Older residential areas often have backyard easements which make access to the tap even more difficult to reach due to locked gates, guard dogs, and trespassing concerns. During a service procedure, the risk of employee personal injury and homeowner property damage is greatly increased. If a tap cannot be located by sight, it is required to review system maps usually by laptop computer which may not be readily available to all in-house “company” technicians and not typically available to hired third party installation contractors. Often the pedestal is not locked properly by the previous technician and is fully accessible to the general public. Some locks at the pedestal can be defeated by anyone with a 7/16′ nut driver tool common in most households today. Other pedestals require specialty keys that may not be available to every technician. This forces the tech to either to call a co-worker to provide the proper keys, drill out the lock for immediate access, or postpone the job until the tap can be properly accessed. This procedure can cost time, cause permanent damage to the cable pedestal, and leave a customer frustrated that the call could not be completed during the scheduled time frame.

If the drop cable from the tap to the service delivery location is fed directly to an exposed splitter mounted to the side of the house with no protective enclosure (“cable box,”) the wires may not be well-protected against weather damage and can appear messy. A professional installation often includes a weather-resistant enclosure mounted outside the customer's premises to protect the splitter and fittings from environmental exposure. The existing house boxes used by the industry are unlocked and vulnerable to tampering by the customer, competition, and general public. If the wiring is modified after the installation, a service technician may be obliged to perform tests and/or make changes at both the premises box and nearby tap, which can increase time at the job and decrease efficiency.

An improved cable entry box that can extend the system's physical and electrical integrity to the outside of each service delivery point may improve system performance and reduce service and maintenance costs.

### SUMMARY

Embodiments of the invention are generally rectangular protective housings in a “clamshell” configuration, adapted for mounting against a flat, vertical surface such as a wall, and constructed to provide protection from sun, dust and water to low-voltage and signal wires (including fiber-optic cables) that are contained within. An embodiment comprises a plurality of openings to admit the cables into the interior of the housing. A separately-lockable partition divides the interior of the housing into controlled and uncontrolled volumes, so that cables and connections within the controlled volume are less easily accessible to unauthorized individuals.

### BRIEF DESCRIPTION OF DRAWINGS

FIG. 1 is a perspective view of an embodiment of the invention.

FIG. 2 is a perspective view of the embodiment in a second configuration.

FIG. 3 explains the nomenclature used in describing embodiments of the invention.

FIG. 4 is a detail showing an electrical connector assembly used for its non-electrical, mechanical properties to lock the interior partition that controls access to a portion of the interior volume of an embodiment.

FIG. 5 is an inferior perspective view of an embodiment in the completely closed configuration.

FIG. 6 is a front view of a closed embodiment.

FIG. 7 is a bottom view of a closed embodiment.

FIG. 8 is a clasp-side view of a closed embodiment.

### DETAILED DESCRIPTION

Cable enclosures according to the inventive design allow a cable broadband company to change the demarcation point from the neighborhood or cluster “tap” to the house-box level while still providing a physically and electrically secure termination point. Some benefits of the invention are: reducing technician time at each service call (which increases efficiency); providing a cosmetically aesthetic enclosure to professionally hide cable wires; improving security protection from theft of services or cut lines from burglary; decreasing the potential of signal interference and increasing system reliability; and lowering the risk of employee personal injury or homeowner property damage.

### Nomenclature

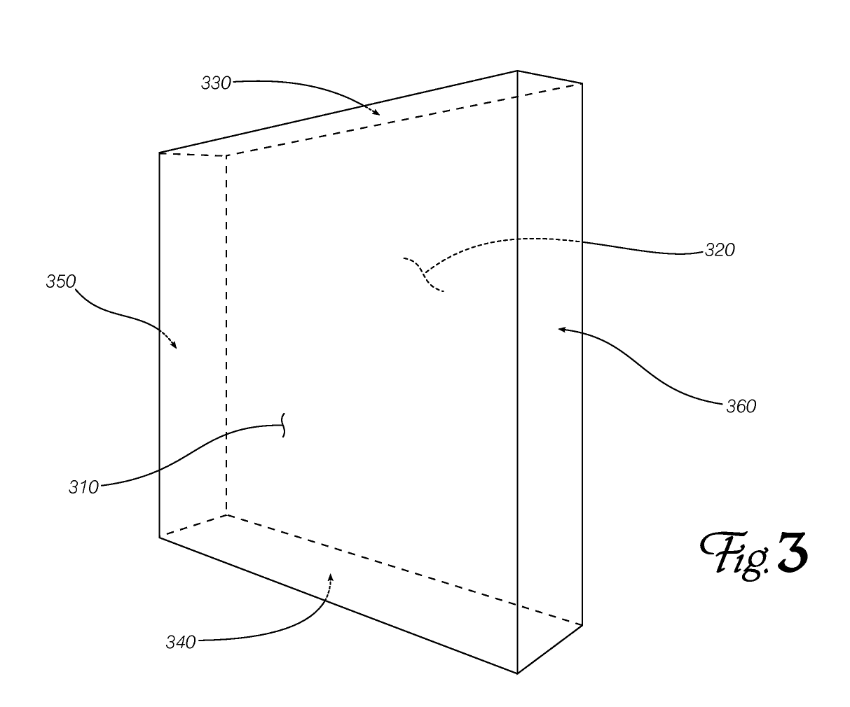

For clarity and avoidance of doubt, Applicants provide the following specific definitions to assist in understanding the following description. Turning briefly to FIG. 3, a rectangular prismatic shape is shown. The six sides or faces are identified as follows: 310 is the “front” face; 320 is the “back” face; 330 is the “top” face (when an embodiment is mounted in its normal position against a vertical surface); 340 is the “bottom” face; 350 is the [left] “side” face; and 360 is the [right] “side” face. Embodiments may have curved, convex or concave faces for aesthetic, manufacturability or other reasons, but the foregoing nomenclature will be used to the extent possible.

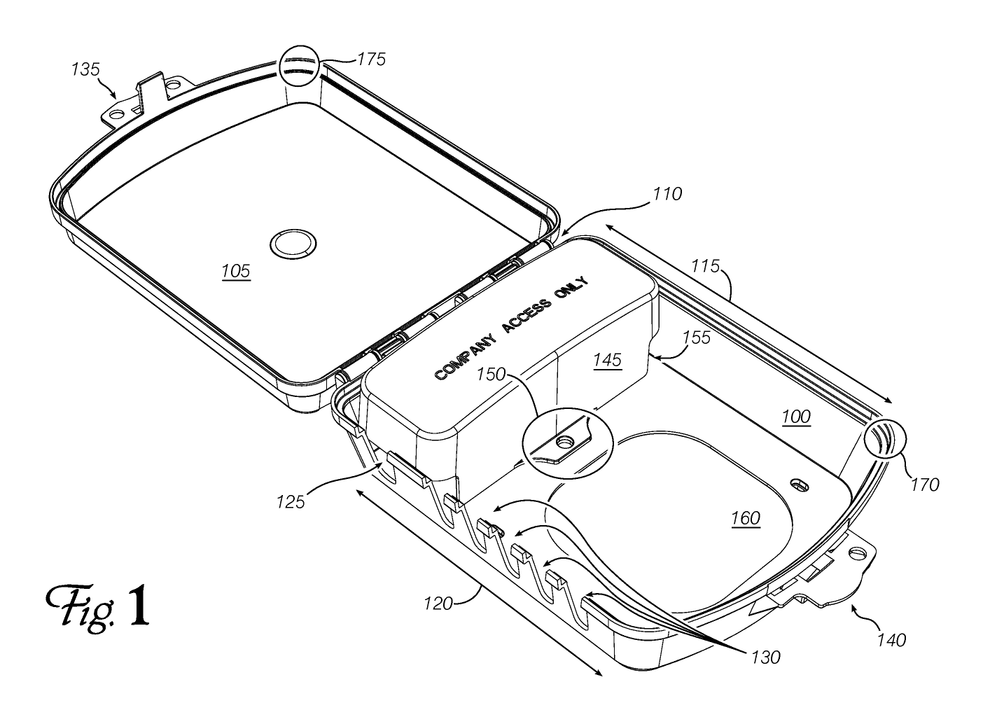

FIG. 1 shows a perspective view of an embodiment of the invention, with many of the inventive features identified. The embodiment is a generally rectangular, clamshell-style hollow enclosure with a back shell 100 suitable for mounting against a flat, vertical surface, connected to a mating front shell 105 along a hinge line 110. The depths of the front and back shells may be similar, as shown here, or one may be significantly deeper than the other. For example, most of the depth of the enclosure may be defined by the back shell, while the front shell is more like a thin, flat door.

The enclosure has a top side 115 that is in the uppermost position when the enclosure is mounted on a wall or other surface, and a bottom side 120 opposite the top side. Preferably, the top side has no openings so that water and debris cannot easily enter the enclosure. However, the bottom side has several openings 125, 130 to admit one or more flexible cables (not shown). The openings may be partially protected with grommets or flexible sheets to help prevent water & debris entry through the bottom.

Complementary latch mechanisms 135, 140 hold the front and back shells together when the enclosure is closed. These mechanisms may accommodate a keyed or combination lock if such locking is permitted by regulation and desired by the entity maintaining the enclosure.

An embodiment further comprises an internal shell or partition 145, which divides the interior of the enclosure into two separate compartments or volumes. In this example, the internal partition shares the hinge with the front and back shells, but separately-hinged internal shells may also be used. The internal shell has a separate locking mechanism (circled at 150) which permits access to the internal compartment to be controlled separately from access to the interior of the enclosure but outside the internal compartment. Preferably, at least one of the openings to the exterior (125 in this example embodiment) admits flexible cables into the internal, access-controlled compartment. Cables entering and/or passing through the internal compartment can pass into the second, non-access-controlled interior portion of the enclosure through an opening 155. In many embodiments, the back shell includes an opening 160 through which the mounting surface can be seen and accessed. The mounting surface may be, for example, an exterior wall of a structure, and cables passing through or terminated on one end inside the enclosure may enter the structure by passing through opening 160, rather than by exiting through one of the exterior openings and then entering the structure through a different aperture.

Mating edges of the front and back shells (e.g., at 170 and 175) may be snugly-fitting concentric lips or interlocking channels, and may be provided with a rubber or silicone gasket to help prevent water ingress.

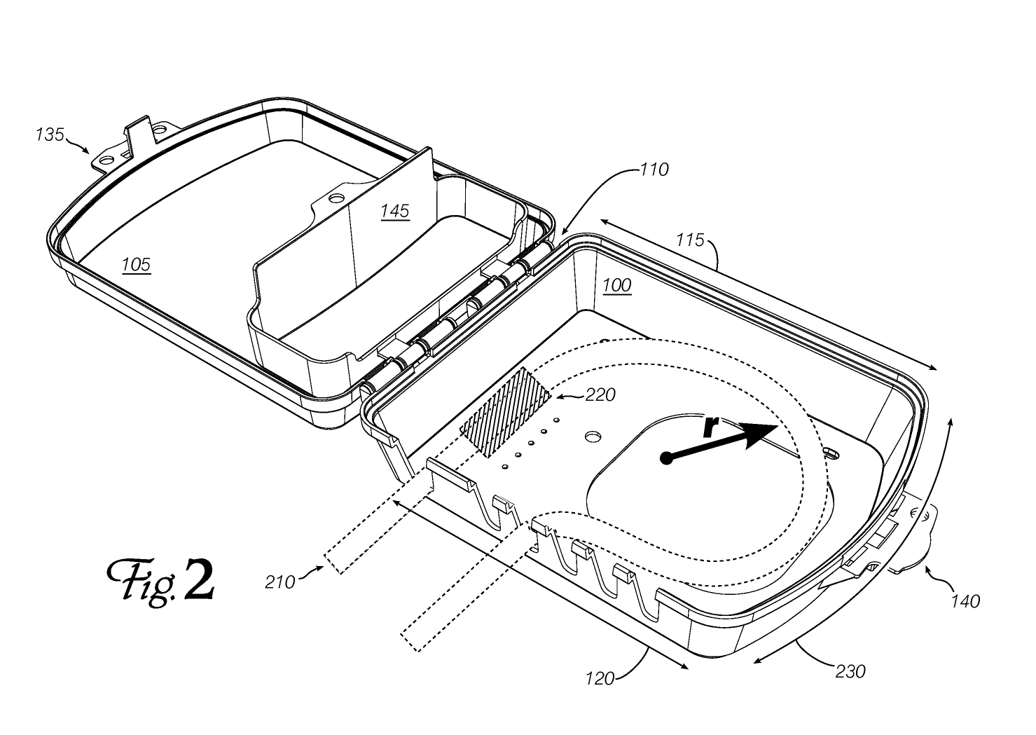

FIG. 2 shows the same embodiment with the internal partition 145 flipped up and over the hinge to expose the access-controlled internal compartment. Many of the features identified in FIG. 1 are marked in this Figure as well, to aid in understanding the relationship between the Figures. FIG. 2 shows how an example flexible data cable 210 may enter the enclosure through one opening, pass through the access-restricted compartment (access is restricted when shell 145 is closed and secured) and through to the unrestricted volume inside the enclosure.

Note that the cables often used with embodiments of the invention have a minimum bend radius, indicated here as ‘r’. Forcing such a cable to bend more sharply than the minimum radius may damage the cable or alter its electrical or optical characteristics so that signal transmission is impaired. An embodiment should be sized so that the cables that will be used can enter and exit the enclosure without excessive bending. In the embodiment shown in FIGS. 1 and 2, note that the latch side of the enclosure has a convex curvature (e.g., at 230). This reduces the amount of cable bending slightly, and may permit the installation of cable connectors, splitters and/or other hardware that would otherwise require undesirable small-radius cable bending. Embodiments of the invention are preferably sized to suit the installation of RG-11, RG-6, or RG-59 cable, with a minimum bend radius of about 4.5″, 3″, and 2.5″ respectively. An embodiment for use with a particular type of cable should be sized so that a circular loop of the cable can be contained fully within the housing without bending more sharply than allowed. An arc of this circular loop should pass through the access-controlled inner compartment, while the rest of the loop passes through the uncontrolled volume outside the inner compartment.

Preferably, an embodiment provides at least one mounting boss for a grounding block (e.g. 220) located within the access-controlled portion of the enclosure. When the entering cable is securely connected to such a ground block, the service provider can be more confident that its data signals will not suffer interference from substandard wiring at the service location. The interior shell protects this connection, so a technician may not need to find or access the tap distribution point when performing service at the residence.

It is appreciated that the interior shell may not provide high levels of physical security (i.e., the property owner may be able to break into the protected portion of the enclosure and damage the ground connection) but the interior shell may be tamper-evident, so that a service technician can see that the protected connection has been accessed and know that further electrical or signal tests may be required to troubleshoot a service problem.

FIG. 4 shows a detail of the lock structure securing the interior shell or partition. (The exterior latch or lock may be entirely conventional.) For the interior closure, it may be difficult or impossible to distribute a unique key for a conventional lock to every person who might need to access the protected area. Instead, in a preferred embodiment, a common electrical connector and a specialty tool for the connector are used for the non-standard purpose of physically closing and securing the interior door. Service technicians who should have access to the protected circuitry carry these connectors and tools as a matter of course; but individual service recipients do not have them, and so cannot easily access or tamper with the protected connections.

In the embodiment shown here, an “F type connector coupler” 410 is inserted through a hole 420 in the back shell 400 of the enclosure before the enclosure is secured to the structure (e.g., residence). A flange 415 on the connector coupler prevents it from being pulled through the back shell, so when the back shell is mounted to a wall, the coupler is held securely in place. The interior partition includes a flap 453 having a hole 456 that aligns with hole 420 when the inner partition is closed, so that the barrel of the F type connector coupler 410 passes through the hole. Finally, a plunging terminator tool is used to secure a standard electrical terminator 460 (such as a locking 75Ω coaxial cable terminator) to the exposed barrel of the connector coupler. The terminator would normally be used for its electrical or signal-conditioning purpose of preventing signal reflections from an unterminated cable end, but in an embodiment of the invention, the terminator is instead used as a mechanical obstruction for the purpose of preventing the interior partition from being opened.

The F type connector coupler 410 need not be connected to any electrical signal source, or to any cable at all. In fact, in a preferred embodiment, a single-ended “dummy” connector coupler 470 which lacks the internal dielectric structure and conductors may be provided, since these electrical elements are not needed. A dummy (or “hollow”) F type connector coupler may be made less expensively, to less-stringent standards. However, when a dummy coupler is not available, a regular connector coupler may be used.

Similarly, terminator 460 is not preventing or attenuating reflections of any electrical signal, but is instead preventing the interior partition from being opened by mechanically obstructing movement (opening) of the interior shell. Thus, while it should be mechanically similar to a real terminator so that it can be secured and removed with a regular plunging terminator tool, a dummy terminator may be used to reduce cost.

The plunging terminator tool is used by cable service technicians, but is not commonly available to the general public. Furthermore, no commonly-available tools can cleanly remove such a terminator, so any non-technician tampering with the interior partition lock will be evident and will alert a technician to the possibility of non-compliant wiring or attempted service theft.

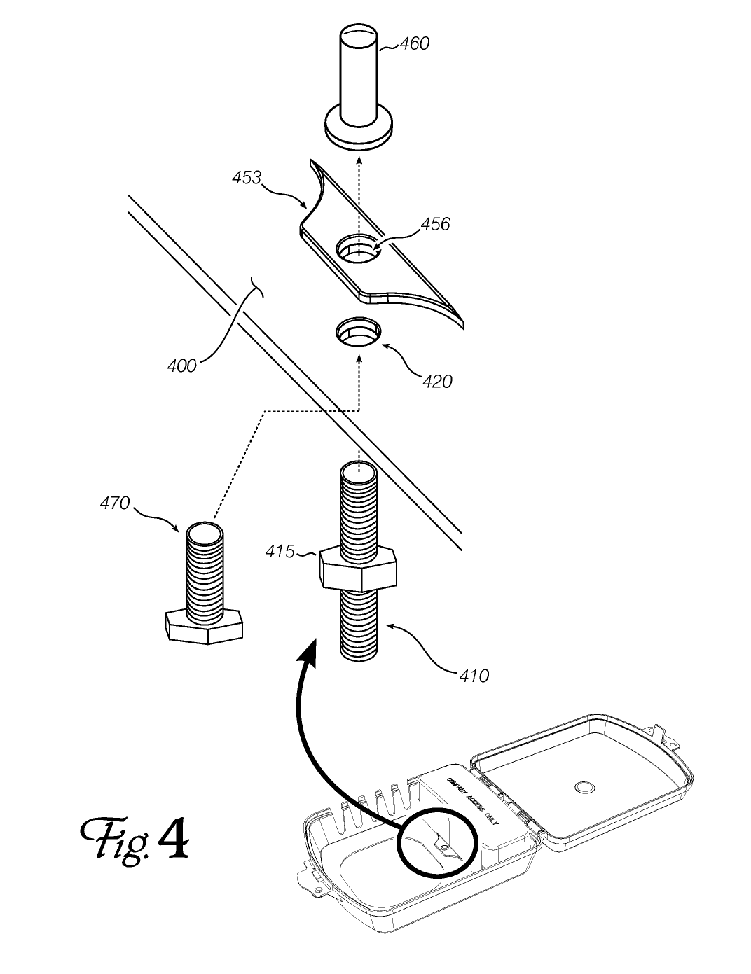

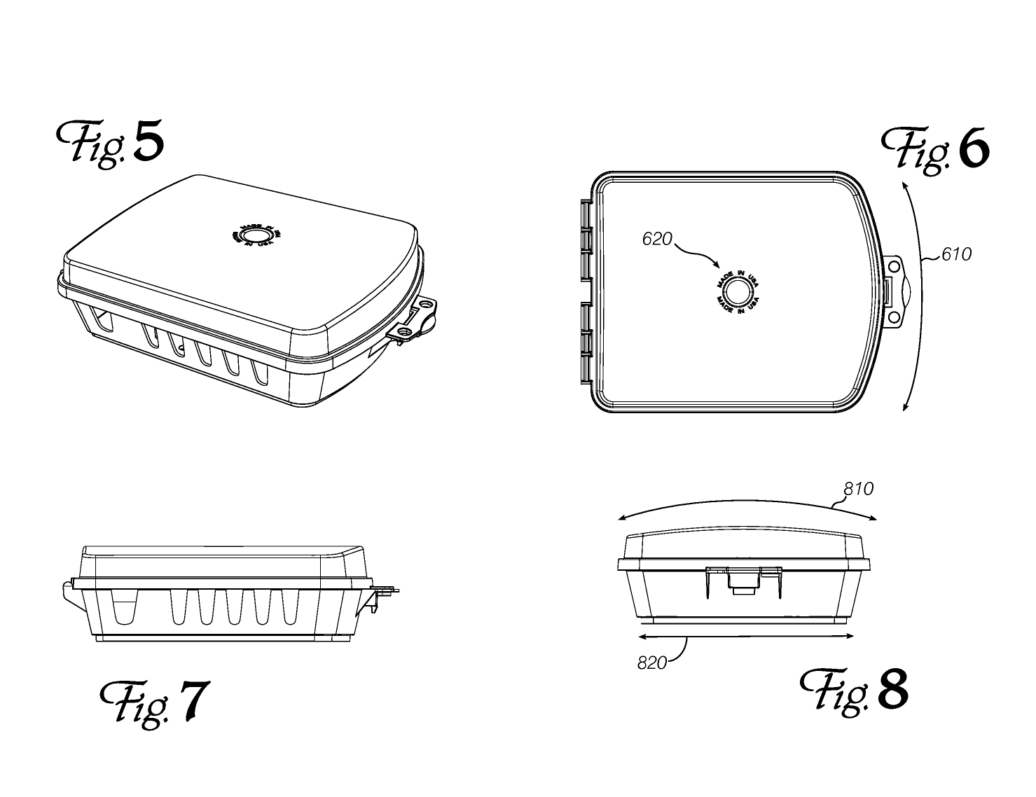

FIGS. 5 through 8 show inferior perspective, front, bottom and right side views, respectively, of an embodiment with interior and exterior doors/shells/covers closed. These views show the general appearance of an embodiment as it would be installed on a residence or other structure. The curvature of the side of the enclosure opposite the hinge is clearly visible in FIG. 6 at 610. The outer shell (front cover) may also be curved about a horizontal axis, as shown in FIG. 8 at 810. The back shell is preferably flat for secure mounting against a vertical surface (820).

Embodiments of the invention may be constructed of a tough, inexpensive, formable (moldable) material such as (cross-linked) polyethylene, polypropylene, polyvinyl chloride (“PVC”), acrylonitrile butadiene styrene (“ABS”), epoxy, polycarbonate, or a similar substance. The mating surfaces between the front and back enclosure shells may be provided with a gasket to improve sealing and moisture resistance. The interior partition may be formed of the same material as the exterior shells, or a different material.

Materials suitable for use in an embodiment may be impregnated or coated with a dye, pigment or colored coating, or colorized in a similar way. Dark colors (or black) may be preferred to distinguish these housings from other utility enclosures affixed to the same structures. These other enclosures (e.g., electrical service entries, circuit breakers, telecommunications panels and the like) are often colored grey, so embodiments of a different color can serve as a visual signifier for a technician, allowing him to quickly differentiate the various access points during daylight. An embodiment may comprise a reflective thermal stamp or logo on the front surface (e.g., FIG. 6 at 620) to improve visibility under reduced illumination conditions. The stamp or logo may also provide valuable advertising to the homeowner and visitors to the property.

Embodiments of the present invention have been described largely by reference to specific examples and in terms of particular mechanical structures and configurations. However, those of skill in the art will recognize that cable protection and access control can also be accomplished by designs that implement the principles of this invention differently than the examples described herein. Such variations and alternate implementations are understood to be captured according to the following claims.

We claim:

1. A generally rectangular clamshell housing, comprising:
a back shell adapted for mounting against a flat surface, said back shell having a hinge side, a top side, a latch side opposite the hinge side, and a bottom side opposite the top side, the top side arranged to prevent liquid from entering the clamshell housing when the back shell is mounted against a flat surface, the bottom side configured to admit at least one flexible cable, and the latch side having a first component of a lockable clasp;
a front shell connected to the back shell along the hinge side, said front shell having a top side corresponding to the top side of the back shell, a bottom side corresponding to the bottom side of the back shell, and a latch side corresponding to the latch side of the back shell, said front shell latch side having a second, complementary component of the lockable clasp; and
a cable entry shell lying within the generally rectangular clamshell housing formed by the back shell and the front shell, said cable entry shell having a separate and independent locking mechanism, said cable entry shell having a first opening to admit the at least one flexible cable entering the bottom side of the back shell and a second opening to permit the at least one flexible cable to exit the cable entry shell and pass into an interior compartment of the clamshell housing.

2. The generally rectangular clamshell housing of claim 1 wherein the latch side of the housing has a convex curvature to relax a bend radius of the at least one flexible cable passing into the housing through the first opening and exiting the housing through a third opening.

3. The generally rectangular clamshell housing of claim 1 wherein the separate locking mechanism comprises:
an electrical connector that is not connected to a signal source; and
an electrical terminator coupled to the electrical connector.

4. The generally rectangular clamshell housing of claim 3 wherein the electrical connector is an F type connector coupler.

5. The generally rectangular clamshell housing of claim 3 wherein the electrical connector is a dummy F type connector coupler.

6. The generally rectangular clamshell housing of claim 3 wherein the electrical terminator is a 75Ω terminator.

7. The generally rectangular clamshell housing of claim 3 wherein the electrical terminator is a dummy 75Ω terminator.

8. The generally rectangular clamshell housing of claim 1 wherein the back shell comprises an opening to expose a surface of a structure when the back shell is mounted to the structure.

9. A covered, partitioned cable entry box, comprising:
an outer closeable, lockable outer container having at least one opening to permit a flexible cable to pass from outside the outer container through and into the outer container when the outer container is fully closed;
an inner closeable, separately lockable inner partition fully within the outer container, said inner partition located so that the flexible cable may pass from outside the outer container through and into a controlled volume defined by the inner partition, and from inside the controlled volume through and into an uncontrolled volume inside of the outer container, external to the controlled volume.

10. The covered, partitioned cable entry box of claim 9, further comprising:
a mounting boss inside the controlled volume, located so that a conductor secured to a grounding block mounted on the mounting boss cannot be disconnected when the inner partition is closed.

11. The covered, partitioned cable entry box of claim 9 having three substantially straight sides and one curved side.

12. The covered, partitioned cable entry box of claim 11 wherein the curved side is opposite one of the three substantially straight sides, said opposite substantially straight side carrying a hinge between a front outer shell and a back outer shell, said front and back outer shells together forming substantially all of the outer closeable, lockable outer container.

13. The covered, partitioned cable entry box of claim 9 wherein a complete circular loop of cable having a minimum bend radius of 4.5″ may be contained within the outer container, an arc of such loop passing through the inner partition.

14. An outdoor, protective cable enclosure, comprising:
a plastic clamshell enclosure box adapted to be secured to a flat, vertical surface, said enclosure box having a first opening to admit a flexible cable into a first interior volume of the enclosure box, and a second opening to admit a flexible cable into a second interior volume of the enclosure box,
the first and second interior volumes separated by a locking partition disposed within the enclosure box, said locking partition having at least one opening to permit a flexible cable to pass from the first interior volume to the second interior volume through the at least one opening.

15. The outdoor, protective cable enclosure of claim 14 wherein a size of the first and second interior volumes, a spatial relationship between the first and second interior volumes, the first and second openings, and the at least one opening are suitable to permit the flexible cable to enter the first interior volume, pass from the first interior volume to the second interior volume, and exit from the second interior volume without falling below a minimum bend radius of the flexible cable.

16. The outdoor, protective cable enclosure of claim 15 wherein the flexible cable is one of an RG-11 cable, an RG-6 cable or an RG-59 cable.

17. The outdoor, protective cable enclosure of claim 15 wherein the minimum bend radius of the flexible cable is between about 2.5″ and about 4.5″.

18. The outdoor, protective cable enclosure of claim 14, further comprising:
a locking mechanism to secure the locking partition, said locking mechanism comprising:
an opening to accept an F type connector coupler before the cable enclosure box is secured to the flat, vertical surface and to retain the F type connector coupler after the cable box is secured to the flat, vertical surface; and
an opening in the locking partition corresponding to the F type connector coupler so that the locking partition may be closed over the F type connector coupler and secured in a closed position by fixing a terminator to the F type connector coupler using a plunging terminator tool.

19. The outdoor, protective cable enclosure of claim 14, further comprising:
a grounding block fixed within the first interior volume and covered by the locking partition when the locking partition is closed so that connections to the grounding block are inaccessible while the locking partition is closed.

20. The outdoor, protective cable enclosure of claim 14, formed chiefly of a material selected from the group consisting of polyethylene, polypropylene, polyvinyl chloride (“PVC”), acrylonitrile butadiene styrene (“ABS”), epoxy and polycarbonate.
